(19) United States
(12) Patent Application Publication
(10) Pub. No.: US 2013/0071826 A1
(43) Pub. Date: Mar. 21, 2013

(54) Auscultation Training System

(71) Applicant: Keith H. Johnson, Friendswood, TX (US)

(72) Inventor: Keith H. Johnson, Friendswood, TX (US)

(21) Appl. No.: 13/238,125

(22) Filed: Sep. 21, 2011

(51) Int. Cl. G09B 23/28

(52) U.S. Cl. 434/266

(57) ABSTRACT

An auscultation training system is disclosed comprising a half-body mannequin with speakers providing heart, lung, bowel and bruit sounds in the correct anatomical positions for student training of auscultation with a standard stethoscope. An integrated computer system provides the tools for training and assessing students. Synchronized phonocardiograms and a palpable carotid pulse accompany heart sounds. Sounds can be played and auscultated simultaneously to simulate a live patient, or played and auscultated separately for teaching purposes. The system may be accessed online using a virtual mannequin and stethoscope for viewing and listening to heart, lung, bowel and bruit sounds.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to educational training systems, and more particularly to an auscultation training system utilizing a software application to playback pre-recorded sounds for different categories of auscultation sounds at various listening sites in a half-body mannequin.

### DISCUSSION OF RELATED ART

Portable training systems that facilitate learning of auscultation have been widely developed for assisting teachers and medical practitioners. Various devices like mannequins, electronic stethoscopes, computer programs and sound simulators have been devised to digitally record, store, modify and play different sounds and murmurs characteristic to various human organs. Most of these systems require the use of a special stethoscope integrated into the training system. Such systems include a sound generator and converter for converting the sound signals to an audible sound for humans. Most of the conventional systems do not integrate a broad variety of instruments commonly used in the reproduction of sounds and do not provide any platform to incorporate different kinds of training scenarios in a cost efficient manner.

An electronic auscultation system and method for simulating sounds arising from human organs has been described in U.S. Pat. No. 6,220,866 issued to Amend on Apr. 24, 2001. The system includes a patient simulating mannequin torso, a plurality of electro-magnetic transmitters having antenna coils positioned in predetermined locations beneath the torso surface. Each transmitter is connected to one or more computer sound cards which, upon activation, generate signals from prerecorded sound data which produces the appropriate sounds of human organs based on the transmitter locations. The system utilizes a simulated stethoscope that includes a receiver and/or sensing triggering devices so that the stethoscope can determine particular areas on the torso to define the appropriate sound generated. Such a system does not allow training with a normal stethoscope nor does such a system expose the students to a larger number of sounds and murmurs with descriptions, lectures/lessons, phonocardiograms, drawings, and questionnaires controlled by a computer program.

U.S. Pat. No. 6,527,559 issued to Yoshii on Mar. 4, 2003, provides a human sized mannequin for the training of auscultation. The mannequin comprises a core body formed of resin foam that has speakers coupled to a sound reproducing apparatus and is covered by an imitation skin on the outside of the core body. The core body includes recesses corresponding to auscultation sites and a sound reflector with a concaved surface attached to the outside of each speaker. Such a system does not include a provision to integrate a variety of instruments used in the reproduction of sounds. In addition, such a system makes it very difficult to distinguish the variations of sound which can be detected by moving a stethoscope to the various auscultation sites on the mannequin.

U.S. Pat. No. 7,209,796 issued to McKinney on Apr. 24, 2007 discloses an auscultation training apparatus which includes a database of pre-recorded physiological sounds stored on a computer that can be heard utilizing a playback system. A graphical user interface software program is stored on the computer for use with a conventional computer mouse. The program allows a user to select one of the pre-recorded sounds for playback. In addition, the program is operable to generate an inverse model of the playback system in the form of a digital filter. If employed by the user, the inverse model processes the selected sound to cancel the distortions of the playback system so that the sound is accurately reproduced in the playback system. The program also permits the extraction of a specific sound component from a pre-recorded sound so that only the extracted sound component is audible during playback. The program displays a spectrogram along with the selected specific pre-recorded sound. The spectrogram is a display not generally used in auscultation training. Such a system does it allow the user to control the apparatus, or provide different pre-recorded sounds, lessons, nor does it provide the capability to adjust the volume of the sound or trace size of the images. In addition, such a device does not produce real sounds, pulse, phonocardiograms/phonopneumograms, lectures, student assessments, heart/lung combinations or web-based software.

U.S. Pat. Application No. 20100279262 entitled to Lecat on Nov. 4, 2010 discloses an auscultation training device that utilizes a medical training mannequin, a controller, and a database of auscultation training sound data to simulate and communicate the sounds of the human body to users. The invention is able to initiate the playback of prerecorded sounds via a variety of trigger mechanisms, and transmit live sounds, or combinations of sounds, to remote examiners. Such a device does not produce real sounds, heart/lung combinations, pulse, phonocardiograms, phonopneumograms, lectures, student assessments, or web-based software.

Therefore, there is a need for an auscultation training system utilizing a software application to playback pre-recorded sounds and pulses for different categories of auscultation sounds and pulses at various listening sites in a half-body mannequin. Such a needed system would allow students and trainers to utilize standard stethoscopes for the auscultation training. Such a system would expose the students to a larger number of sounds, including heart/lung combinations, pulses and murmurs with descriptions and lessons, lectures, phonocardiograms, drawings, questionnaires, short videos and student assessments. Such a system would allow the user to control the system to provide different pre-recorded sounds, lectures/lessons and questionnaires, and control the volume of the sound at each anatomical location and trace size of the images on the graphical user interface (GUI) of the software application. Such a system would also allow the user to compare two or more pre-recorded sounds and provide a means to enable more than one user to listen to the sounds. The system would also include a graphical user interface (GUI) that provides a mannequin display area and a corresponding sound display area for phonocariograms or phonopneumograms, allowing the user to self-study auscultation techniques and learn the location of events such as murmurs and clicks.

### SUMMARY OF THE INVENTION

An embodiment of the present invention is an auscultation training system utilizing a software application to playback pre-recorded, simulated and real physiological sounds for different categories of heart, bruit, breath and bowel sounds and arterial pulses at various anatomically correct listening and palpation sites in a half-body mannequin. The auscultation training system enables a user to listen to and experience various auscultation sounds using a standard stethoscope. The system comprises the half-body mannequin, a computer system and an interface module to connect the computer system with the mannequin. The half-body mannequin comprises a plurality of speakers installed at anatomically correct sound listening sites and relays installed at anatomically correct palpation sites for the transmission of a palpable pulse. The interface module converts the digital signals from the computer system into the analog signals necessary for the speakers and relays. The computer system is electronically connected to the interface module with one or more digital connections and the interface module is electronically connected to the speakers and relays in the mannequin with multiple analog connections. The computer system comprises one or more software applications with a graphical user interface for the selection of a plurality of pre-stored heart, breath, bowel and bruit sounds and pulses for transmission to the interface module. The user interface also provides for the simultaneous graphical display of phonocardiogram and phonopneumogram waveforms for every sound, so students may view the sounds as they are heard which aids in training for detection of location of murmurs or other events that are systolic or diastolic.

The plurality of category of physiological sounds may include heart sounds, breath/lung sounds, bowel sounds, bruit sounds, heart and breath combination sounds and heart and bruit combination sounds. Sounds also include Valsalva maneuvers, egophony, bronchophony and pectoriloquy. Sounds can be played and heard simultaneously to simulate a live patient, or played and heard separately for teaching purposes.

To aid in training, pulse and respiration rate may be varied. Heart sounds may be heard at 60, 75, 90 and 110 beats per minute and respiration rate may vary from 12 to 30 breathes per minute. Transmission of the carotid pulse is timed with the first heart sound to aid the student identification of systole. Breath sounds may be heard on both the upper and lower anterior and posterior lung. Lungs may be separated with different volume settings. Sounds in the database include all generally recognized pediatric sounds to include ASD, PDA, VSD, primary Pulmonary Hypertension, Pulmonary Stenosis, third heart sounds, Eisenmenger's Syndrome, summation sounds and Tetralogy of Fallot. Users may palpate certain murmurs known as physiologic thrills and certain breath sounds may be palpated, known as tactile fremitus.

The mannequin is a full size replica of a human torso, neck and head, without arms. It is portable, weighing approximately 23 pounds and can be used in the upright or left lateral position. The mannequin is latex free.

In addition to allowing the user to select sounds and pulses to be transmitted to the interface module, the user may select preset lessons related to each of the plurality of pre-recorded sounds or choose from a selection of editable lectures that includes a collection of physiological sounds. The system also allows the user to create and save lectures and tests/assessments related to each of the plurality of pre-recorded sounds. Tests/assessments consist of a collection of sounds, much like for a lecture, but without the written explanation of the sounds. Thus allowing the student to listen, palpate and optionally view the phonocardiograms or phonopneumograms of each sound in the collection before identifying the sound presented.

The software application provides a comparison selection function to select two or more pre-recorded sounds for performing a comparative study. Students can quickly compare any two sounds to learn how to distinguish between similar sounds. For instance, a pleural rub of the lung has a similar sound to a pericardial friction rub of the heart. The application allows for a quick, back and forth comparison of the two sounds.

The software application may be a web-enabled application. In this mode, there is no connection to the interface module or mannequin. The computer system or external speakers are used to listen to the heart, lung, bruit and bowel sounds. The graphical user interface includes a virtual mannequin display area which displays the half-body mannequin with a plurality of listening sites corresponding to each of the plurality of pre-recorded sounds. The virtual mannequin display area further displays a virtual stethoscope that allows the at least one user to click on the plurality of listening sites and listen to the plurality of pre-recorded sounds. The graphical user interface displays a simultaneous corresponding phonocardiogram for each of the plurality of prerecorded sounds on the graphical user interface when placing the virtual stethoscope on each of the plurality of listening sites.

The sound repository means is organized as a disk folder having the plurality of sub-folders for digitally storing the database of the plurality of pre-recorded sounds for the plurality of category of auscultation sounds. Each of the plurality of pre-recorded sounds is arranged as a .wav file format. Each .wav file format for each of the plurality of pre-recorded sounds includes the plurality of interleaved sound signal which is presented as a is standard audio 7.1 formatted container. The sound repository means is stored in an encrypted file format into a hidden folder. When at least one of the plurality of pre-recorded sounds is selected by the at least one user for playback, the encrypted file is decrypted to a particular .wav file format corresponding to the selected pre-recorded sound and copied from the hidden folder to a virtual disk. The sound repository means is then encrypted and the particular decrypted .wav file format in the virtual disk is submitted to a windows media player for playback. If the user selects another one of the plurality of pre-recorded sounds for playback, the previously existing particular .wav file format in the virtual disk is replaced. Thus the process is repeated for selection of each of the plurality of pre-recorded sounds. The virtual disk is highly volatile in nature and it empties the contents when the software application terminates. Finally, the particular .wav file is submitted to the interface module or, when functioning without the interface module and mannequin, the file is submitted to a sound codec of the sound engine module from the windows media player to generate the plurality of interleaved sound signals for each of the plurality of pre-recorded sounds at each of the plurality of sound listening sites. The database of the plurality of pre-recorded sounds for the plurality of category of physiological sounds includes a plurality of attributes for each of the plurality of pre-recorded sounds. The plurality of attributes may include saved and default sound attenuation levels for each of the plurality of interleaved sound signals, channel trace defaults, trace scaling defaults, sound multiplexing target assignments and lecture/lesson assignments. Instructors may determine how often students access this program.

### DESCRIPTION OF THE DRAWINGS

FIG. 1 is a schematic view of an auscultation training system in accordance with an embodiment of the present invention;

FIG. 2 is a front view of an interface module associated with a half-body mannequin in accordance with an embodiment of the present invention;

FIG. 3 is an exemplary screen illustration of an embodiment of the present invention, illustrating a main window displayed on a graphical user interface of the computer system installed with a software application;

FIG. 4 is an exemplary screen illustration of an embodiment of the present invention, illustrating a sound select page showing the list of a plurality of pre-recorded sounds for each of a plurality of category of auscultation sounds;

FIG. 5 is a block diagram illustrating the functionality of a sound repository means associated with a computer system;

FIG. 6 is a block diagram illustrating the functionality of a sound engine module embedded within the half-body mannequin;

FIG. 7 is an exemplary screen illustration of an embodiment of the present invention, illustrating a lecture page showing the details of preset lectures/lessons related to each of the plurality of prerecorded sounds;

FIG. 8 is an exemplary screen illustration of an embodiment of the present invention, illustrating a create lecture page that allows the user to create and save the lectures/lessons related to each of the plurality of prerecorded sounds;

FIG. 9 is a block diagram illustrating the functionality of a lecture sequence link in the main window;

FIG. 10 is a front elevational view of the half-body mannequin showing a plurality of listening sites for heart and bruit sounds;

FIG. 11 is an elevational view of the half-body mannequin showing the plurality of listening sites on both anterior and posterior portions for breath/lung sounds; and

FIG. 12 is a front elevational view of the half-body mannequin showing the plurality of listening sites for bowel sounds.

### DETAILED DESCRIPTION OF THE PREFERRED EMBODIMENT

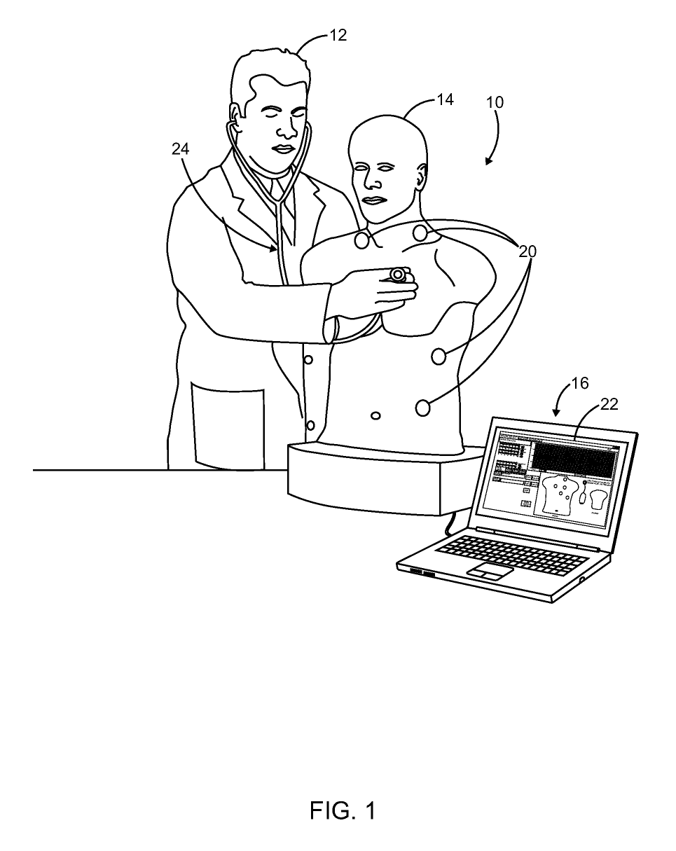

FIG. 1 is a schematic view of an auscultation training system 10 that enables the at least one user 12 to listen to and experience various physiological sounds. The system 10 comprises a half-body mannequin 14, a computer system 16 installed with a software application and an interface module (not shown). The half-body mannequin 14 comprises a plurality of sound listening sites 20. The computer system 16 comprises a database of a plurality of pre-recorded sounds for a plurality of category of physiological sounds in the form of a sound repository means that includes a plurality of sub-folders. The software application facilitates the at least one user 12 to access a tabbed graphical user interface 22 defined in the form of a main window.

The interface module which is in electronic communication with the sound repository means is embedded in the half-body mannequin 14. The interface module is configured to receive pre-recorded sounds for the plurality of category of physiological sounds and to generate a plurality of interleaved sound signals for each of the plurality of pre-recorded sounds at each of the plurality of sound listening sites 20. A standard stethoscope 24 is used to hear the audible sounds transmitted to the speakers in the mannequin.

The system 10 allows the at least one user 12 to select at least one of the plurality of pre-recorded sounds for at least one of the plurality of category of physiological sounds in the graphical user interface 22 and to playback the plurality of interleaved sound signals corresponding to the selected pre-recorded sounds at respective sound listening sites 20.

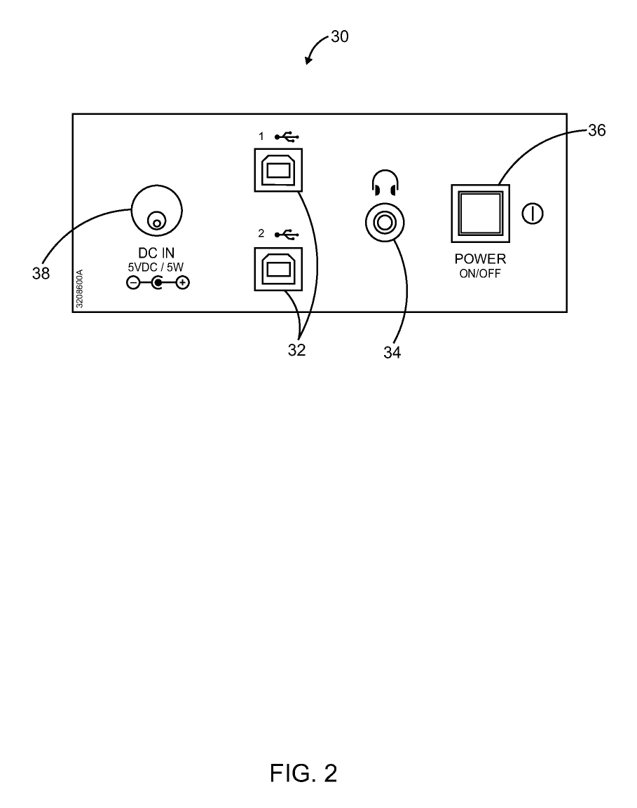

FIG. 2 is an external front view of an interface module 30 associated with the half-body mannequin 14. The interface module 30 includes a pair of universal serial bus ports 32, a headphone connection port 34, an on/off switch 36 and a power supply port 38. The computer system 16 is operatively connected to the pair of universal serial bus ports 32 and optional external speakers or an optional electronic stethoscope which may be connected to the headphone connection port 34. The power supply port 38 is connected to the DC to power the electronic components within the half-body mannequin 14. The half-body mannequin 14 should be operated in an environment cooler than 80° F. or 27° C. The plurality of interleaved sound signals can be listened to using at least one speaker (not shown) connected to the headphone connection port 34.

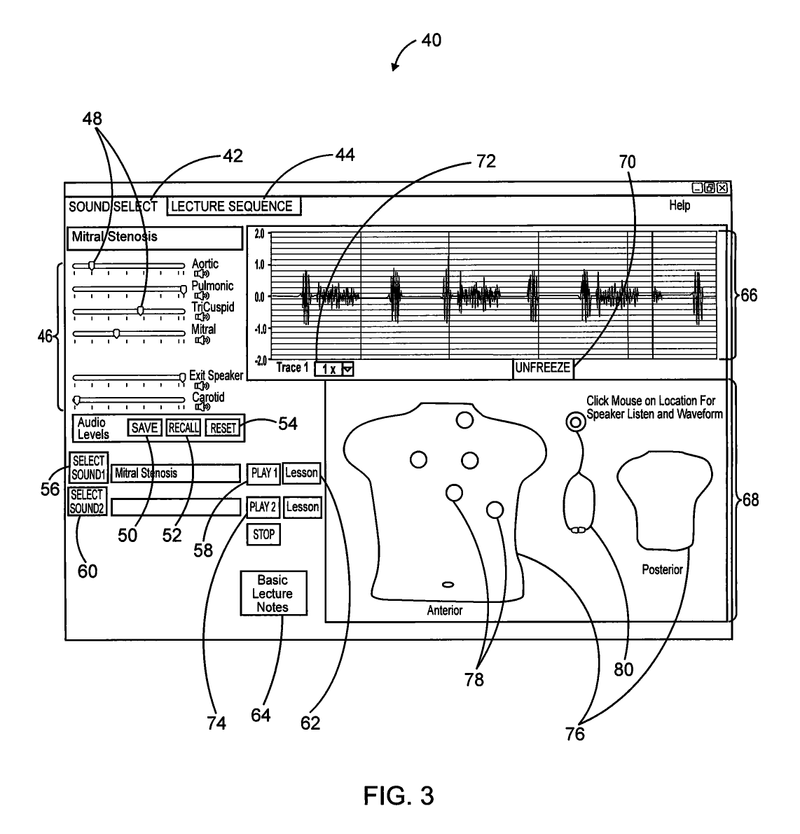

FIG. 3 is an exemplary screen illustration of an embodiment of the present invention, illustrating a main window 40 displayed in the graphical user interface 22 of the computer system 16 which is installed with the software application. The software application may be a web enabled application which will allow simultaneous use of the system by multiple users. In this mode, sounds are transmitted to the user's computer or external speaker rather than to the interface module. The main window 40 includes a link to sound select 42, which allows the at least user 12 to access a sound select page giving the details of each of the plurality of category of auscultation sounds with the plurality of pre-recorded sounds. The main window 40 further includes a link to lecture sequence 44, which allows the at least one user 12 to access a lecture page giving the details of the preset lectures/lessons related to each of the plurality of pre-recorded sounds.

Referring to FIG. 3, the main window 40 includes a volume adjust area 46, a volume save button 50, a recall button 52, a reset button 54, a select sound button 56, a play sound button 58, a compare sound button 60, a select lesson button 62, a basic select lecture button 64, a phonocardiogram display area 66, a virtual mannequin display area 68, a freeze trace button 70 and a trace size button 72. The volume adjust area 46 allows the at least one user 12 to change volume of each of the plurality of pre-recorded sounds at each of the plurality of listening sites 20. This can be performed by moving one or more volume slide bars 48 in the volume adjust area 46. The volume save button 50 arranged below the volume slide bars 48 allows the at least one user 12 to save the selected volume level. The recall button 52 arranged next to the volume save button 50 allows the at least one user 12 to recall the settings. The reset button 54 allows the at least one user 12 to return to the previously saved volume levels. The at least one user 12 can access the sound select page by clicking the sound select button 56. The sound select page includes the details of each of the plurality of category of physiological sounds with the plurality of pre-recorded sounds. The play sound button 58 allows the at least one user 12 to play the plurality of pre-recorded sounds shown in the sound select page.

The compare sound button 60 allows the at least one user 12 to select two or more pre-recorded sounds for performing a comparative study. The pre-recorded sounds can be toggled with the use of buttons such as play 1 indicated herein as 58 and play 2 indicated as 74 on the main window 40. The mannequin display area 68 displays a virtual half-body mannequin 76 with a plurality of listening sites 78 corresponding to each of the plurality of pre-recorded sounds. The mannequin display area 68 further displays a virtual stethoscope 80 that allows the at least one user 12 to click on the plurality of listening sites 78 and listen to the plurality of pre-recorded sounds. The phonocardiogram display area 66 displays a graphical depiction of a selected pre-recorded sound when the at least one user 12 clicks on respective listening site. When the at least one user 12 compares two or more pre-recorded sounds, more phonocardiograms are displayed in different colors. Each color indicates the graphical depiction of each of the selected pre-recorded sound. The select lecture button 62 allows the at least one user 12 to view the lecture/lessons corresponding to the selected pre-recorded sound. Each lesson includes a description of the sound, a schematic of a chest, phonocardiograms, questions and answers and a basic lesson on cardiac auscultation. The basic select lecture button 64 allows the at least one user 12 to access default basic notes stored in the software application related to each of the plurality of pre-recorded sounds. The freeze trace button 70 allows the at least one user 12 to freeze the phonocardiogram and simultaneously listen to the selected pre-recorded sound. The trace size button 72 allows the at least one user 12 to increase or decrease the amplitude of the signals in display areas 66, 68 for better viewing.

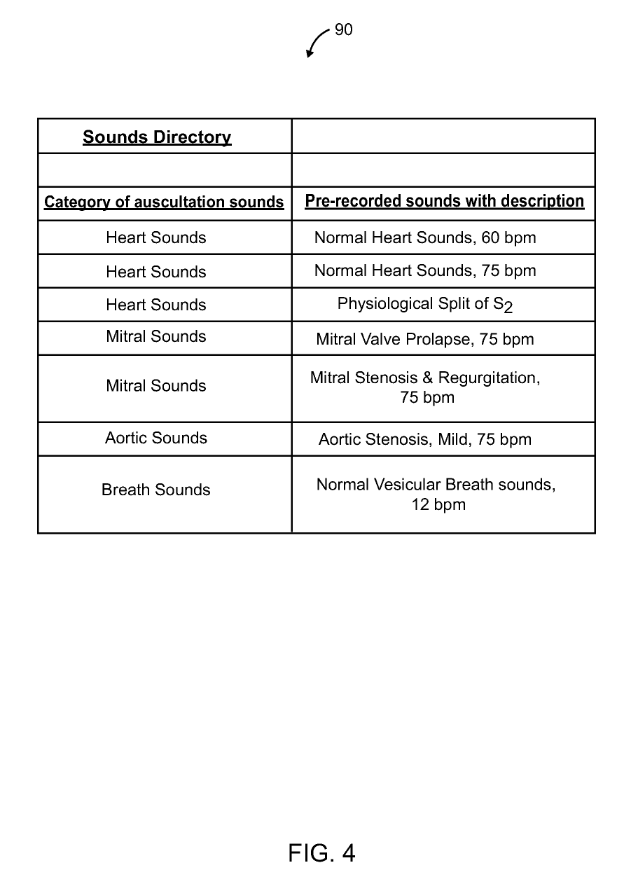

FIG. 4 is an exemplary screen illustration of an embodiment of the present invention, illustrating a sound select page 90 showing the list of a plurality of pre-recorded sounds for each of a plurality of category of physiological sounds. The at least one user 12 can choose one or more pre-recorded sounds from the list and listen to the sounds at the plurality of listening sites 20 on the half-body mannequin 14 using a standard stethoscope 24. The plurality of category of physiological sounds may include heart sounds, breath/lung sounds, bowel sounds, bruit sounds, aneurysms, heart and breath combination sounds and heart and bruit combination sounds.

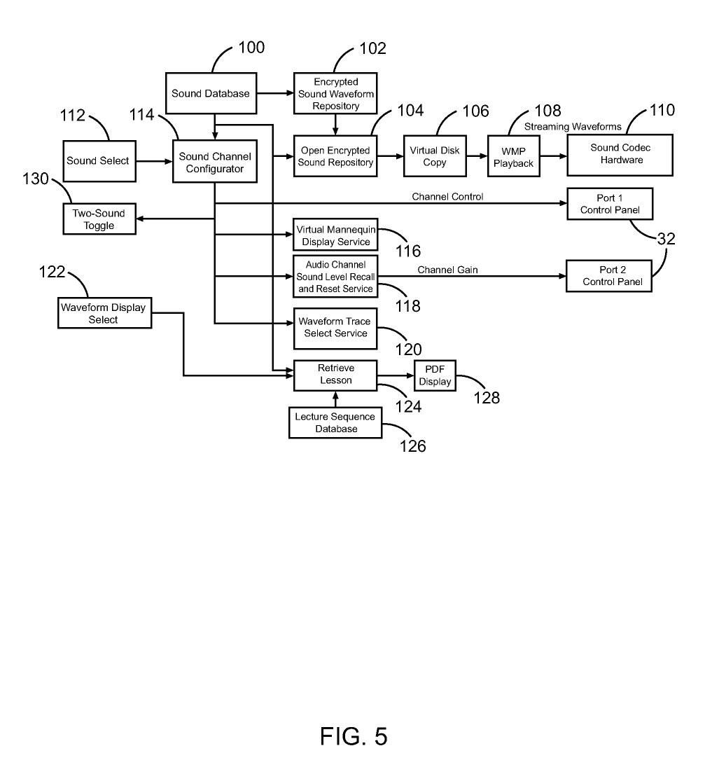

FIG. 5 is a block diagram illustrating the functionality of a sound repository means associated with a computer system 16. The sound repository means is organized in the form of a disk folder that includes the plurality of sub-folders for storing the database of the plurality of pre-recorded sounds 100 for the plurality of category of physiological sounds. Each of the plurality of pre-recorded sounds is arranged as a .wav file format. Each .wav file format for each of the plurality of pre-recorded sounds includes the plurality of interleaved sound signals and presents as a standard audio 7.1 formatted container. The sound repository means is stored in an encrypted file format 102 into a hidden folder. When at least one of the plurality of pre-recorded sounds is selected by the at least one user 12 for playback, the encrypted file gets decrypted 104 to a particular .wav file format corresponding to the selected pre-recorded sound and copied from the hidden folder to a virtual disk 106. The sound repository means is then encrypted and the particular decrypted .wav file format in the virtual disk is submitted to the windows media player 108 for playback. If the at least one user 12 selects another one of the plurality of pre-recorded sounds for playback, the previously existing particular .wav file format in the virtual disk is replaced. Thus the process is repeated for selection of each of the plurality of pre-recorded sounds. The virtual disk is highly volatile in nature and it disposes of the contents when the software application terminates. Finally, the particular .wav file format is submitted to sound codec hardware 110 in the interface module from the windows media player 108. The database of the plurality of pre-recorded sounds for the plurality of category of physiological sounds 100 includes a plurality of attributes for each of the plurality of pre-recorded sounds. The plurality of attributes may include saved and default sound attenuation levels for each of the plurality of interleaved sound signals, channel trace defaults, trace scaling defaults, sound multiplexing target assignments and lectures/assessments.

When the at least one user 12 selects the sound select button 112, the plurality of attributes of the database 100 stored in a sound channel configurator 114 is activated. This facilitates the activation of virtual half-body mannequin display service 116, audio channel sound level recall and reset service 118, and waveform trace select service 120. When the at least one user 12 selects a waveform display select 122 for lectures/lessons, the basic notes and the preset lectures/lessons 124 related to each of the plurality of pre-recorded sounds in the software application can be retrieved from the database 100 and a lecture sequence database 126. The lectures/lessons are displayed in the graphical user interface 22 in a portable document format (PDF) 128. The audio channel sound level recall and reset service 118 promotes the volume adjustments, and the waveform trace select service 120 promotes the display of phonocardiogram in the graphical user interface 22 for each of plurality of pre-recorded sounds. The at least one user 12 has the ability to select two pre-recorded sounds for comparison. The pre-recorded sounds can also include a toggle feature 130 to toggle the sounds with the use of buttons such as play 1 as indicated as 58 and play 2 indicated as 74 on the graphical user interface 22. A channel control and a channel gain for the sound repository means in the computer system are connected with the pair of universal serial bus ports 32 on the interface module of the half-body mannequin 30.

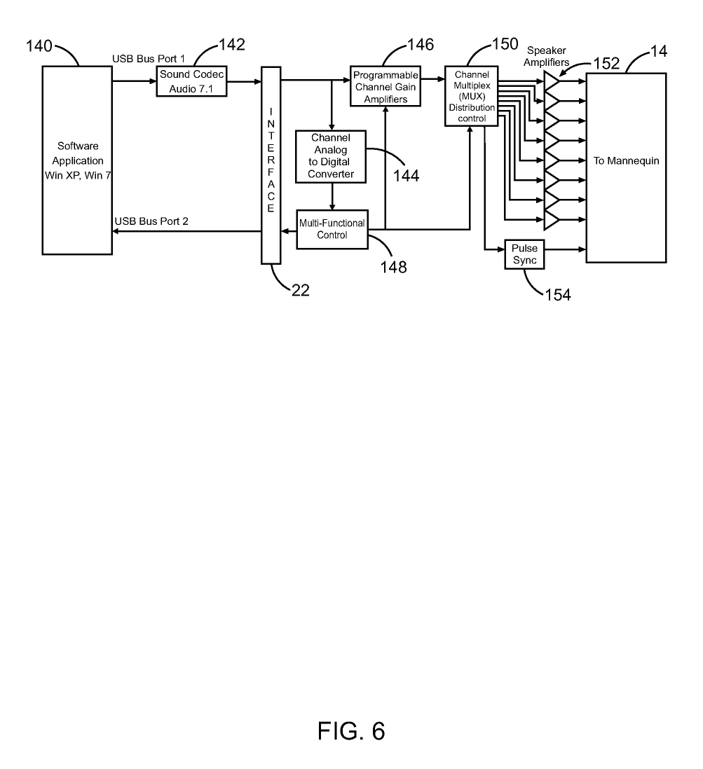

FIG. 6 is a block diagram illustrating the functionality of an interface module embedded within the half-body mannequin 14. Sounds from the computer system are sent to a commercial-off-the-shelf (COTS) eight channel USB audio adapter external sound card 142. The analog signals from the sound card are simultaneously directed to a multiplexer 150 for the output to the speakers in the mannequin and to an A/D converter 144 in a COTS data acquisition module for transmission to the computer system for display as waveforms on the user interface 22. The multiplexer 150 allows for routing the analog signals to the proper speakers and provides for the user to enable or disable speakers. The interface module 30 also provides a demodulation circuit and a pulse driver 154 to activate the pulse solenoid in sync with the heart sounds. The sound codec hardware may be a streaming codec hardware device and the multifunction board may be a universal serial bus (USB) multifunction board. The streaming codec hardware is installed separately with its own USB drivers. The streaming codec hardware may be a 7 channel USB Audio Adapter External Sound Card that can output 8 sounds such as front right and left, rear right and left, center, bass and surround right and left. The streaming codec hardware installation provides a virtual audio interface module where a one-time audio 7.1 user selection can be performed. The multifunction board is a data acquisition (DAQ) module that can input 8 analog and input/output 12 digital sounds. Each standard audio 7.1 formatted container 142 of each of the plurality of the pre-recorded sounds in the software application 140 is channeled to an analog to digital converter 144, to a programmable channel gain amplifiers 146, to a multifunctional control 148 and to a channel multiplex (MUX) distribution control 150 in the sound engine module. The graphical user interface 22 connects the sound repository means of the computer system to the interface module of the half-body mannequin 14.

The multifunction board can perform the multifunctional control 148 to the programmable channel gain amplifiers 146, and to the channel multiplex (MUX) distribution control 150. The multifunction board can perform a continuous 400 Hz sampling of each of the channel MUX distribution control 150 for achieving a tracing of waveform to a waveform graph. The programmable channel gain amplifiers 146 are actually utilizing a resistive attenuation method. The resistive range can be programmatically changed with 64 steps of equal resistive granularity.

The streaming codec hardware receives the standard audio 7.1 formatted container 142 from the windows media player and generates the plurality of interleaved sound signals for each of the plurality of pre-recorded sounds at each of the plurality of sound listening sites. The plurality of interleaved sound signals may be in eight in number. The plurality of interleaved sound signals can be heard using a standard stethoscope through the speakers 152 integrated with the half-body mannequin 14. The sound engine module includes pulse sync 154 that acts as a target for carotid pulse sound.

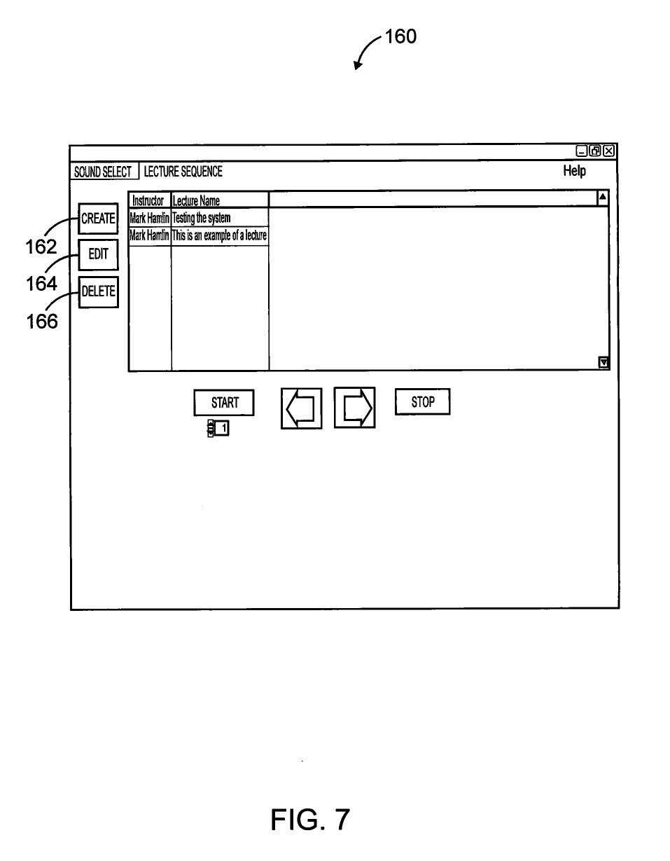

FIG. 7 is an exemplary screen illustration of an embodiment of the present invention, illustrating a lecture page 160 showing the details of the preset lectures/lessons related to each of the plurality of prerecorded sounds. The lecture page 160 includes a create lecture button 162, an edit lecture button 164 and a delete lecture button 166. The at least one user 12 can preprogram the lectures/lessons related to each of the pre-recorded sounds using the editing tool provided by the user interface. Each user may have multiple lectures/lessons each with a different title. The lecture page 160 also allows the at least one user 12 to save student assessments related to each of the lectures/lessons.

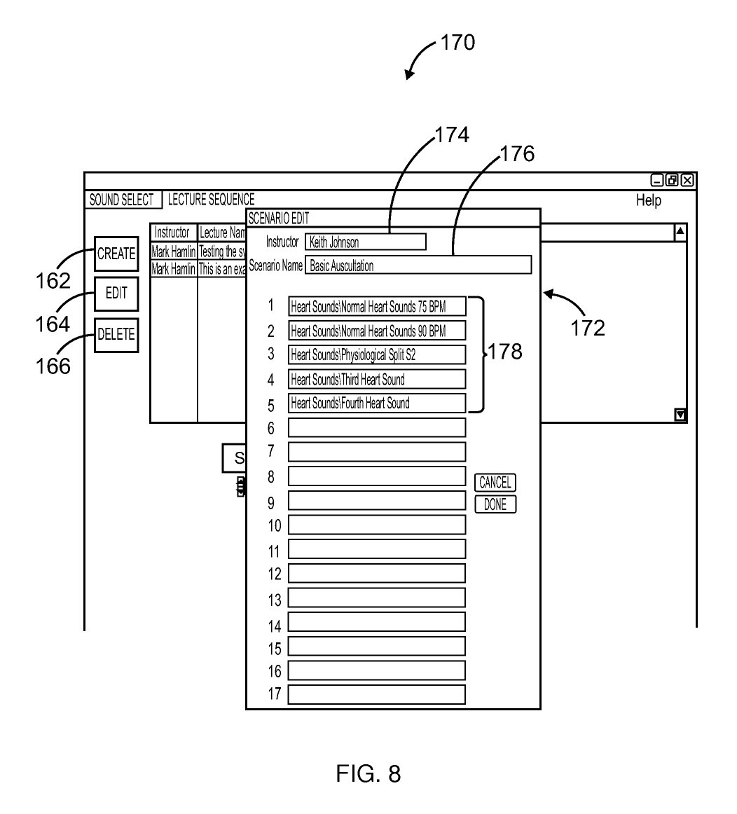

FIG. 8 is an exemplary screen illustration of an embodiment of the present invention, illustrating the create lecture button 162 that allows the at least one user 12 to create and save the lectures related to each of the plurality of prerecorded sounds. When the at least one user 12 clicks on the create lecture button 162, it navigates to a create lecture page 170. The at least one user 12 can fill a lecture panel 172 with his/her name 174 and lecture name 176. Then the user 12 can select and list the plurality of pre-recorded sounds 178 which are pertaining to the filled lecture name 176.

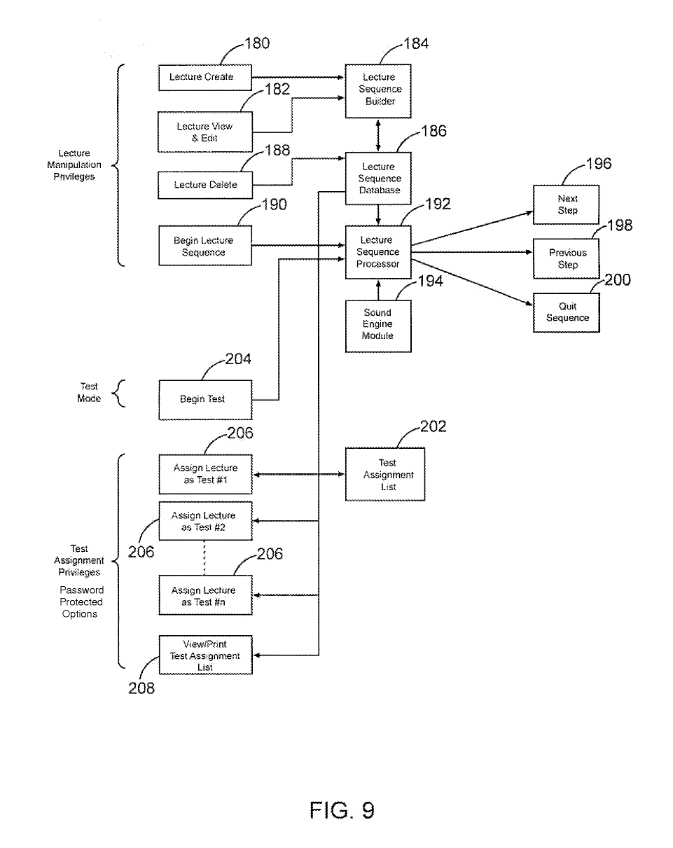

FIG. 9 is a block diagram illustrating the functionality of a lecture sequence link 44 displaying in the main window 40. The at least one user 12 can create a lecture sequence 180, view or edit lecture a sequence 182 to build a sequence of the plurality of prerecorded sounds into lecture steps 184 for facilitating student lectures, student self-teaching and student testing.

The at least one user 12 can assign the build sequence 184 to a unique name into the lecture sequence database 186. The at least one user 12 can build a sequence of up to 20 different pre-recorded sounds. Within the lecture sequence database 186 an unlimited number of sequences can be saved. The functionality of lecture sequence may be protected by password/account lecture manipulation privileges. Such privileges allow the user 12 to create 180, edit 182 and delete 188 the lecture sequences. With user selection of one of the lecture sequences 190 from the lecture sequence database 186, a lecture sequence processor 192 initiates the lecture sequence and executes it step-by-step. At each step a selected pre-recorded sound will in playback through the sound engine module 194 using next step 196, previous step 198, and quit sequence 200 virtual buttons.

The lecture sequence database can be assigned to a test assignment list 202 for test mode operation and to execute the lecture sequences either in test mode or non-test mode. According to the user's selection of one of the test from the lecture sequence database 186, a lecture sequence processor 192 initiates the test 204 and executes it step-by-step in the test mode. In the test mode, the lecture sequence includes a list of tests, names, descriptions, and functionality which are hidden. The lecture sequence database 186 includes the test assignment privileges such as assign number of test 206 and view/print the test assignment list 208.

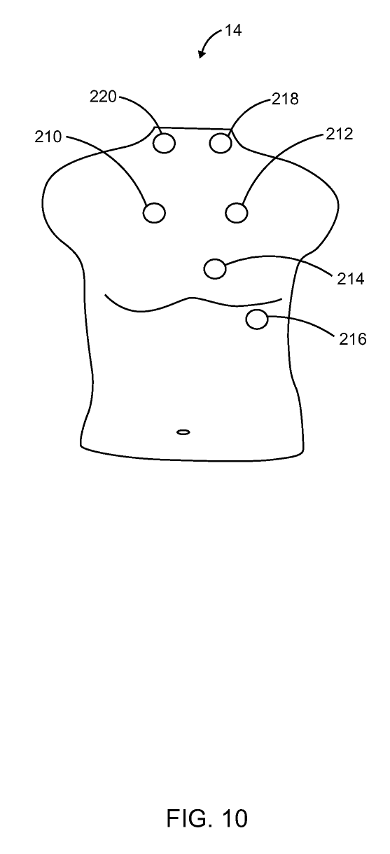

FIG. 10 is a front elevational view of the half-body mannequin 14 showing the plurality of listening sites for heart and bruit sounds. The heart sounds include five listening sites such as aortic 210, pulmonic 212, tricuspid 214, mitral 216 and carotid pulse 218. The bruit sounds include one listening site such as carotid bruit 220.

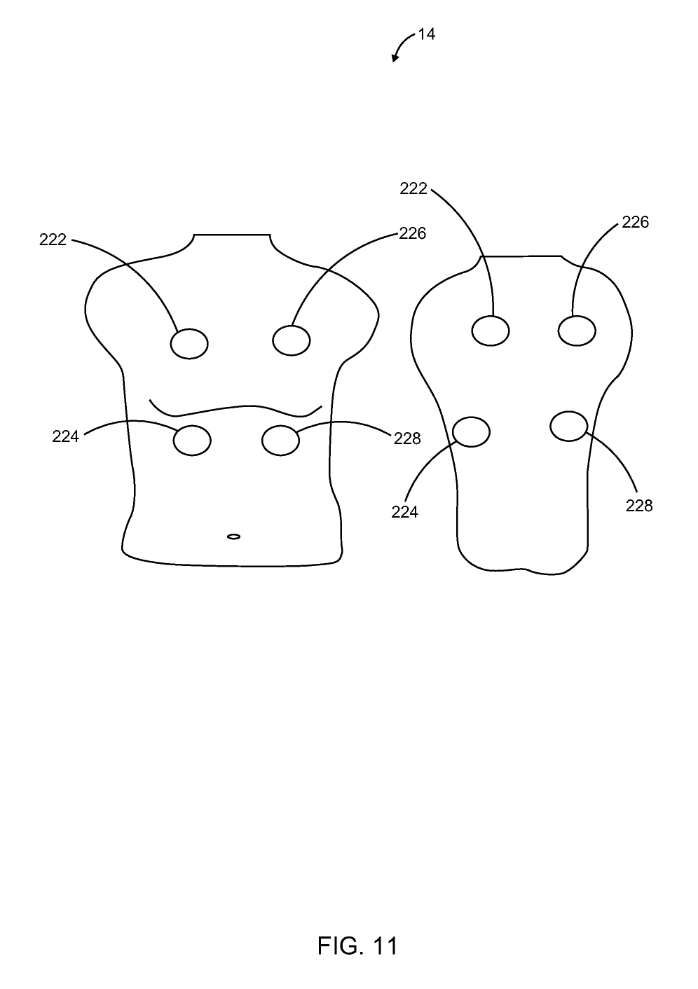

FIG. 11 is elevational views of the half-body mannequin 14 showing the plurality of listening sites on both anterior and posterior portions for breath/lung sounds. The breath/lung sounds include four listening sites such as upper right lung 222, lower right lung 224, upper left lung 226 and lower left lung 228 on the anterior portion of the half-body mannequin 14. The breath/lung sounds further include four listening sites such as upper right lung 222, lower right lung 224, upper left lung 226 and lower left lung 228 on the posterior portion of the half-body mannequin 14.

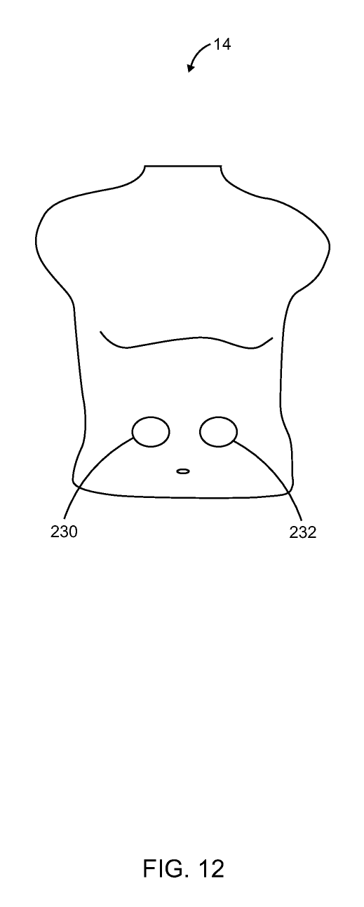

FIG. 12 is a front elevational view of the half-body mannequin 14 showing the plurality of listening sites 20 for bowel sounds. The bowel sounds include two listening sites such as upper right quadrant 230 and upper left quadrant 232.

While particular embodiments of the invention have been illustrated and described, it will be apparent that various modifications can be made without departing from the spirit and scope of the invention. For example, the software application may include additional functionality such as videos and metrics related to the pre-recorded sounds. Accordingly, it is not intended that the invention be limited, except as by the appended claims.

What is claimed is:

1. An auscultation training system for use with a standard stethoscope comprising:
a) a half-body mannequin having a plurality of speakers providing heart, lung, bowel and bruit sounds in the correct anatomical positions in said mannequin, said speakers in said mannequin operatively connected to an interface module;
b) said interface module in electronic communication with a computer system, said interface module being configured to convert digitally transmitted sounds from said computer system into analog signals for said speakers in said mannequin; and
c) said computer system installed with one or more software applications and comprising a database of a plurality of physiological sounds for auscultation, said software applications facilitating at least one user to access a graphical user interface for the selection of said sounds for transmission to said interface module and graphically displaying said sounds as phonocardiogram waveforms on said graphical user interface.

2. The auscultation training system of claim 1 wherein said mannequin further comprises at least one relay for the transmission of a palpable arterial pulse in the correct anatomical position, said interface module being further configured to convert digital pulse signals from said computer system into analog signals for said at least one relay in said mannequin to provide said palpable arterial pulse synchronized with said at least one heart sound in said mannequin.

3. The auscultation training system of claim 1 wherein said graphical user interface further facilitates said at least one user to vary heart and respiration rate in said at least one physiological sound.

4. The auscultation training system of claim 1 wherein heart and lung combination sounds may be selected, displayed and auscultated with a standard stethoscope.

5. The auscultation training system of claim 1 wherein heart sound changes during a Valsalva maneuver may be selected, displayed and auscultated.

6. The auscultation training system of claim 1 wherein said database further comprises at least one auscultation lesson and said at least one user may select said at least one auscultation lesson to be displayed.

7. The auscultation training system of claim 1 wherein said database further comprises at least one auscultation lecture comprising a collection of said heart, lung, bowel and bruit sounds; said graphical user interface further comprises an editing tool for user modification of said auscultation lecture, a tool for display of said lecture with descriptions of said sounds for purposes of training and a tool for display of said lectures without descriptions of said sounds for purposes of student assessment.

8. The auscultation training system of claim 1 wherein said user interface further comprises a tool for a comparison selection function to select two or more pre-recorded sounds for performing a comparative study.

9. The auscultation training system of claim 1 wherein at least one speaker in said mannequin can transmit physiologic thrills and tactile fremitus which may be palpated by said at least one user.

10. The auscultation training system of claim 1 wherein said lung sounds may be auscultated on anterior or posterior of said mannequin.

11. An auscultation training system comprising a computer installed with one or more software applications and a database of a plurality of pre-recorded heart, breath, bowel and bruit sounds for a plurality of categories of physiological sounds for simulated auscultation, said software applications facilitating at least one user to access a graphical user interface for the selection from said sounds for transmission to at least one internal or external speaker on said computer and graphically displaying said sounds as phonocardiogram waveforms on said graphical user interface.

12. The auscultation training system of claim 11 wherein said graphical user interface further facilitates said at least one user to vary heart and respiration rate in said at least one physiological sound.

13. The auscultation training system of claim 11 wherein heart and lung combination sounds may be selected, displayed and heard simultaneously.

14. The auscultation training system of claim 11 wherein heart sound changes during a Valsalva maneuver can be selected, displayed and heard.

15. The auscultation training system of claim 11 wherein said database further comprises at least one auscultation lesson and said at least one user may select said at least one auscultation lesson to be displayed.

16. The auscultation training system of claim 11 wherein said database further comprises at least one auscultation lecture comprising a collection of said heart, lung, bowel and bruit sounds; said graphical user interface further comprises an editing tool for user modification of said auscultation lecture, a tool for display of said lecture with descriptions of said sounds for purposes of training and a tool for display of said lectures without descriptions of said sounds for purposes of student assessment.

17. The auscultation training system of claim 11 wherein said user interface further comprises a tool for a comparison selection function to select two or more pre-recorded sounds for performing a comparative study.

18. The auscultation training system of claim 11 wherein the at least one user may remotely access the graphical user interface through a web browser application.
